(19) United States
(12) Patent Application Publication
(10) Pub. No.: US 2006/0030516 A1
(43) Pub. Date: Feb. 9, 2006

(54) Rinse-added fabric conditioning composition for use where residual detergent is present

(76) Inventors: Hugo Jean Marie Demeyere, Merchtem (BE); Marc Johan DeClercq, Strombeek-Bever (BE); Serge Gabriel Pierre Cauwberghs, Sint-Niklaas (BE); John Christopher Turner, Overijse (BE); David Xayante Cumming, Northumberland (GB)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 11/243,551

(22) Filed: Oct. 5, 2005

Related U.S. Application Data
(63) Continuation of application No. 11/210,975, filed on Aug. 24, 2005.
Application No. 11/210,975 is a continuation of application No. 10/090,911, filed on Mar. 5, 2002.
(60) Provisional application No. 60/294,178, filed on May 29, 2001.
(60) Provisional application No. 60/293,446, filed on May 24, 2001.
(60) Provisional application No. 60/273,929, filed on Mar. 7, 2001.

(51) Int. Cl. C11D 3/00

(52) U.S. Cl. 510/521

(57) ABSTRACT

There is provided a rinse added composition for the conditioning of fabric in a rinse, whereby the composition comprises a fabric softener active, a suds suppressing system and a surfactant scavenger, characterized in that the composition has a suds reduction value of at least about 90% and is free from visible flocs when used in the presence of residual detergent surfactant.

### CROSS REFERENCE TO RELATED APPLICATIONS

This application is a continuation of U.S. application Ser. No. 11/210,975, filed Aug. 24, 2005, which is a continuation of U.S. application Ser. No. 10/090,911, filed Mar. 5, 2002, which claims priority to U.S. Provisional Application Ser. No. 60,294,178, filed May 29, 2001, which claims priority to U.S. Provisional Application Ser. No. 60/293,446, filed May 24, 2001, which claims priority to U.S. Provisional Application No. 60/273,929, filed Mar. 7, 2001, the disclosure of which is incorporated by reference therein.

### TECHNICAL FIELD

The present invention relates to rinse-added fabric conditioning compositions for fabrics, in particular, compositions for use during the hand rinsing of fabrics as well as the rinsing of fabrics in top loaded non-automated washing machines and automated washing machines after the fabrics have been laundered with a detergent composition. The compositions of the present invention are particularly adapted for use in rinsing fabrics that have been washed in a high suds forming detergent composition and where a portion of that detergent composition is carried over with the fabrics into the rinse.

### BACKGROUND OF THE INVENTION

Nowadays, the trends for washing is by using a washing machine whereby the laundry detergent and the softening composition are dispensed from the washing machine via two separate compartments, thereby ensuring the automated release of the detergent at the beginning of the washing process and the release of the softening composition in the rinse process, usually the last rinse process.

In most countries under development, the consumer's washing habit is to wash their garments with either a non-automatic top loaded washing machine (i.e apparatus which comprises two separated cubicles, one for washing or rinsing, and one for spinning), or a basin or bucket. The washing in basins or buckets involves a manually operated process with the multiple cumbersome steps of wetting the fabrics, washing with detergent, wringing, and rinsing thoroughly. Similarly, in non-automatic top loaded washing machines, washing requires placing the fabrics with detergent in the cubicle containing water and providing agitation. The fabrics are then removed from the cubicle containing the detergent liquor, placed in the spinning cubicle where they are spun to remove the major portion of detergent and soils. The detergent liquor is removed from the other cubicle and is replaced with fresh water. The fabrics are transferred back for rinsing. The steps of spinning and rinsing are often repeated several times to obtain acceptably rinsed fabrics.

A unique aspect of washing-by-hand, and/or washing in non-automatic top loaded washing machine, is the high detergent to water ratio and/or the high fabric to water ratio. Indeed, fabrics treated with such detergent compositions usually carry residual detergent to the rinse step. Compared to modern (automatic) washing machines, this problem of detergent carry over is even more acute with manual washing and/or washing in non-automatic top loaded washing machine, as it is due to the poor efficiency of the spinning and/or wringing in between the wash and the rinse steps.

The use of high suds forming detergent compositions and the incidence of hand and non-automated washing of fabrics, in general, is not constrained to any particular geographical region. Although certain areas having limited access to modern appliances have a higher prevalence of hand and non-automated washing, the need to hand-wash, including rinsing, at least certain items of clothing appears universal. For instance, there are still many garments, especially those manufactured from “fine fabric” material (i.e. silk) or those which comprise “soft woven” material (i.e. woolen knitted sweaters) that need to be “laundered by hand”. Likewise, the laundering of “delicates” and “personal” items also typically requires hand-washing to prevent damage thereto.

Conventional detergent products which are currently used for the hand laundering and/or top loading non-automatic washing machine treatments are the so called “High Suds Detergents”. One commonly known feature of these detergent products is that a significant amount of suds appears on top of the wash solution upon agitation. A problem encountered by the consumer is that a significant portion of these suds is carried over into the rinse solution, requiring cumbersome removal by successive rinsing and spinning/wringing with water. Consequently, the hand rinsing of fabric and its drawback of excessive foam is something consumers are familiar with.

The use of a fabric conditioning composition in conjunction with such detergent compositions can create additional problems. Indeed, fabric softener actives may interact with the residual detergent surfactants like anionic surfactants, present in the rinse solution. As a result, poorly soluble flocs form that then float on top of the rinse solution. It is speculated that the presence of flocs arises from the water-insolubility of the softener compound and/or the interaction of the softener compound with the anionic detergent liquor. Notably, the formation of such flocs is particularly troublesome where a high suds forming detergent composition is used to launder the fabrics during the wash cycle.

In addition, softener compounds tend to form a slightly cloudy or turbid rinse bath solution. The clarity of the rinse solution is often perceived by the consumer as a signal of when the fabrics are completely rinsed. In other words, the more turbid the rinse solution, the more rinses the consumer will perform. It is therefore a concern that the use of a fabric conditioning composition that gives a cloudy rinse bath solution may mislead consumers to engage in excessive rinsing of their fabrics.

There is a further problem with the use of fabric conditioning compositions in conjunction with such detergents, in that the interaction between the softener active and the residual detergent surfactant leads to a markedly reduced end effect. Fabrics treated with conventional conditioning compositions in the presence of residual detergent surfactants do not have the preferred soft hand that is typically delivered by the fabric conditioning composition, when used in the absence of surfactant. Not to be limited by theory, but it is believed that the interaction between softener active and detergent surfactant reduces the efficiency of said softener active.

Accordingly, there is a need for a fabric conditioning composition that will reduce the formation of suds, provide a clear rinse solution and deliver the soft hand typical for the fabric conditioning composition used in the absence of detergent surfactant, when the composition is applied in a rinse solution under detergent carry over conditions. Further, there is a need for processes or compositions that will relieve or ease the burden of the hand and non-automated washing while enabling the consumer to enjoy the benefits of using fabric conditioning compositions in combination with high suds forming detergent compositions. Therefore, there is a need for an effective rinsing composition for use in the hand treatment of fabrics while simultaneously providing softness to the treated fabrics.

### SUMMARY OF THE INVENTION

The present invention provides a fabric treatment composition comprising a fabric softener active, a suds suppressing system and a surfactant scavenger, characterized in that the composition has a suds reduction value of at least about 90%, does not form flocs and delivers a soft hand feel to the fabrics when added to a rinse solution containing residual detergent surfactant. The compositions of the present invention preferably comprise a fabric softening active, a suds suppression agent, a surfactant scavenger and optional adjunct ingredients.

The present invention provides for the use of a fabric conditioning composition comprising a fabric softening active, a suds suppression agent, a surfactant scavenger and optional adjunct ingredients in a rinse solution to impart softness to the treated fabrics and reduce suds formation in the rinse solution.

The present invention further provides for the use of a fabric conditioning composition comprising a fabric softening active, a suds suppression agent, a surfactant scavenger and optional adjunct ingredients in a rinse solution to reduce the formation of flocs in the rinse solution.

The present invention further provides for the use of a fabric conditioning composition comprising a fabric softening active, a suds suppression agent, a surfactant scavenger and optional adjunct ingredients to rinse fabrics washed in a high suds forming detergent composition.

In a process aspect of the invention, there is provided a method for rinsing laundered fabrics which comprises the step of contacting fabrics previously washed in an aqueous detergent liquor, with a rinse solution containing a composition of the invention.

In yet a further process aspect of the present invention, there is provided a method for reducing the volume of water consumed in a laundering operation in which a fabric conditioning composition is utilized, the method comprising the steps of washing the fabrics in an aqueous detergent solution, removing a major portion of the aqueous detergent solution, whether through draining, spinning, wringing, partial rinsing or otherwise, and rinsing the washed fabrics in a rinse solution comprising water and a fabric conditioning composition of the present invention, wherein during this rinsing step residual detergent and soil are removed from the fabrics and the fabrics are conditioned.

In a further embodiment of the present invention there is provided an article of manufacture comprising a fabric conditioning composition comprising a fabric softening active, a suds suppression agent, a surfactant scavenger and optional adjunct ingredients; a container for the fabric conditioning composition; and a set of instructions associated with the container, said instructions comprising an instruction to the consumer that laundered fabrics may be rinsed and conditioned in a single rinse solution without the need for extensive rinsing prior to this conditioning step.

### DETAILED DESCRIPTION OF THE INVENTION

All percentages, ratios and proportions herein are by weight, unless otherwise specified. All temperatures are in degrees Celsius (° C.) unless otherwise specified. All documents cited are incorporated herein by reference in their entireties. Citation of any reference is not an admission regarding any determination as to its availability as prior art to the claimed invention.

As used herein, the term “alkyl” means a hydrocarbyl moiety, which is straight or branched, saturated or unsaturated. Unless otherwise specified, alkyl moieties are preferably saturated or unsaturated with double bonds, preferably with one or two double bonds. Included in the term “alkyl” is the alkyl portion of acyl groups.

As used herein, “comprising” means that other steps and other ingredients which do not affect the end result can be added. This term encompasses the terms “consisting of” and “consisting essentially of”.

As used herein, the term “fabric article” means any fabric, fabric-containing, or fabric-like item that is laundered, conditioned, or treated on a regular, or irregular basis. Non-limiting examples of a fabric article include clothing, curtains, bed linens, wall hangings, textiles, cloth, etc. Preferably, the fabric article is a woven article, and more preferably, the fabric article is a woven article such as clothing. Furthermore, the fabric article may be made of natural and artificial materials, such as cotton, nylon, rayon, wool, silk, polycotton, polyester, etc.

As used herein, the term “laundry residue” means any material that may be present either on the fabrics or in the wash liquor during the wash cycle of the laundering process and that is carried over with the laundered fabrics into the rinse bath solution. Thus, “laundry residue” includes but is not limited to, residual soils, particulate matter, detergent surfactants, detergent builders, bleaching agents, metal ions, lipids, enzymes and any other materials that may have been present in the wash cycle solution. Furthermore, excess laundry liquor may be squeezed, wrung, or spun out of a fabric to remove excess laundry residue, prior to adding the fabric to the rinse bath solution. However, such laundry residue is not completely removed (i.e., rinsed out of the fabric with water) prior to adding the fabric to a rinse bath solution. Preferably, laundry residue includes “surfactant residue”, which means a surfactant material that may be present either on the fabrics or in the wash liquor during the wash cycle of the laundering process and that is carried over with the laundered fabrics into the rinse bath solution. Surfactant residue is removably-attached to the fabric surface and/or fabric fibers via hydrophobic/electrostatic attractions, calcium bridging, and/or other types of weak, non-covalent bonds.

As used herein, “rinse bath solution” is the solution used to rinse the fabrics subsequent to their washing. The rinse bath solution may be used in an automated or non-automated washing machine, or in the case of hand washing, may be used in a simple container such as a basin or bucket. The rinse bath solution is initially water before the laundered fabrics and accompanying laundry residue and/or the rinse-added fabric treatment composition are introduced.

As used in the following description and claims, “visible precipitates” or “flocs” refers to flocculated matter which is generally opaque in nature. Although not necessarily solid or compact, such flocs are sufficiently large to be noticeable by the unaided eye, typically, not less than about 0.4 mm when measured along their shortest axis.

### I. COMPOSITIONS OF THE PRESENT INVENTION

A preferred embodiment of the present invention provides a rinse added fabric conditioning composition comprising a fabric softener active, a suds suppressing system and a surfactant scavenger, characterized in that the composition has a suds reduction value of at least about 90%, does not form flocs and delivers a soft hand to the fabrics when added to a rinse solution containing surfactant residue.

A. Fabric Softener Active

Typical levels of incorporation of the softening compound (active) in the softening composition are from about 1% to about 90%, preferably from about 1% to about 70%, more preferably from about 1% to about 40%, and even more preferably between about 2% and about 25%, by weight of the composition.

The softening compounds can be selected from cationic, nonionic, and/or amphoteric compounds. Typical of the cationic softening compounds are the quaternary ammonium compounds or amine precursors thereof as defined hereinafter.

1. Preferred Fabric Softening Active Compounds

A first preferred type of fabric softening active comprises, as the principal active, compounds of the formula
{R₄₋ₘ—N⁺—[(CH₂)ₙ—Y—R¹]ₘ} X⁻ (1)
wherein each R substituent is either hydrogen, a short chain C₁-C₆, preferably C₁-C₃ alkyl or hydroxyalkyl group, e.g., methyl, ethyl, propyl, hydroxyethyl, and the like, poly (C₂₋₃ alkoxy), preferably polyethoxy, benzyl, or mixtures thereof; each m is 2 or 3; each n is from 1 to about 4, preferably 2; each Y is —O—(O)C—, —C(O)—O—, —NR—C(O)—, or —C(O)—NR—; the sum of carbons in each R¹, plus one when Y is —O—(O)C— or —NR—C(O)—, is C₁₂-C₂₂, preferably C₁₄-C₂₀, with each R¹ being a hydrocarbyl, or substituted hydrocarbyl group, and X⁻ can be any softener-compatible anion, preferably, chloride, bromide, methylsulfate, ethylsulfate, sulfate, and nitrate, more preferably chloride or methyl sulfate;

A second type of preferred fabric softening active has the general formula:
[R₃N⁺CH₂CH(YR¹)(CH₂YR¹)] X⁻
wherein each Y, R, R¹, and X⁻ have the same meanings as before. Such compounds include those having the formula:
[CH₃]₃ N⁽⁺⁾[CH₂CH(CH₂O(O)CR¹)O(O)CR¹] Cl⁽⁻⁾ (2)
wherein each R is a methyl or ethyl group and preferably each R¹ is in the range of C₁₅ to C₁₉. As used herein, when the diester is specified, it can include the monoester that is present.

These types of agents and general methods of making them are disclosed in U.S. Pat. No. 4,137,180, Naik et al., issued Jan. 30, 1979, which is incorporated herein by reference. An example of a preferred DEQA (2) is the “propyl” ester quaternary ammonium fabric softener active having the formula 1,2-di(acyloxy)-3-trimethylammoniopropane chloride.

A third type of preferred fabric softening active has the formula:
[R₄₋ₘ—N⁺—R¹ₘ] X⁻ (3)
wherein each R, R¹, and X⁻ have the same meanings as before.

A fourth type of preferred fabric softening active has the formula: 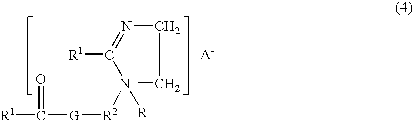
wherein each R, R¹, and A⁻ have the definitions given above; each R² is a C₁₋₆ alkylene group, preferably an ethylene group; and G is an oxygen atom or an —NR— group;

A fifth type of preferred fabric softening active has the formula: 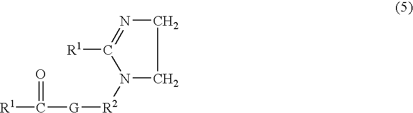
wherein R¹, R² and G are defined as above.

A sixth type of preferred fabric softening active are condensation reaction products of fatty acids with dialkylenetriamines in, e.g., a molecular ratio of about 2:1, said reaction products containing compounds of the formula:
R¹—C(O)—NH—R²—NH—R³—NH—C(O)—R¹ (6)
wherein R¹, R² are defined as above, and each R³ is a C₁₋₆ alkylene group, preferably an ethylene group and wherein the reaction products may optionally be quaternized by the additional of an alkylating agent such as dimethyl sulfate. Such quaternized reaction products are described in additional detail in U.S. Pat. No. 5,296,622, issued Mar. 22, 1994 to Uphues et al., which is incorporated herein by reference;

A seventh type of preferred fabric softening active has the formula:
[R¹—C(O)—NR—R²—N(R)₂—R³—NR—C(O)—R¹]⁺A⁻ (7)
wherein R, R¹, R², R³ and A⁻ are defined as above;

An eighth type of preferred fabric softening active are reaction products of fatty acid with hydroxyalkylalkylenediamines in a molecular ratio of about 2:1, said reaction products containing compounds of the formula:
R¹—C(O)—NH—R²—N(R³OH)—C(O)—R¹ (8)
wherein R¹, R² and R³ are defined as above;

A nineth type of preferred fabric softening active has the formula: 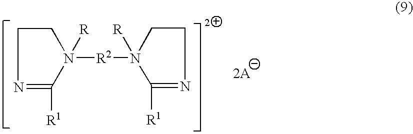
wherein R, R¹, R², and A⁻ are defined as above.

Non-limiting examples of compound (1) are N,N-bis(stearoyl-oxy-ethyl) N,N-dimethyl ammonium chloride, N,N-bis(tallowoyl-oxy-ethyl) N,N-dimethyl ammonium chloride, N,N-bis(stearoyl-oxy-ethyl) N-(2 hydroxyethyl) N-methyl ammonium methylsulfate.

Non-limiting examples of compound (2) is 1,2 di (stearoyl-oxy) 3 trimethyl ammoniumpropane chloride.

Non-limiting examples of Compound (3) are dialkylenedimethylammonium salts such as dicanoladimethylammonium chloride, di(hard)tallowdimethylammonium chloride dicanoladimethylammonium methylsulfate. An example of commercially available dialkylenedimethylammonium salts usable in the present invention is dioleyldimethylammonium chloride available from Witco Corporation under the trade name Adogen® 472 and dihardtallow dimethylammonium chloride available from Akzo Nobel Arquad 2HT75.

A non-limiting example of Compound (4) is 1-methyl-1-stearoylamidoethyl-2-stearoylimidazolinium methylsulfate wherein R¹ is an acyclic aliphatic C₁₅-C₁₇ hydrocarbon group, R² is an ethylene group, G is a NH group, R⁵ is a methyl group and A⁻ is a methyl sulfate anion, available commercially from the Witco Corporation under the trade name Varisoft®.

A non-limiting example of Compound (5) is 1-tallowylamidoethyl-2-tallowylimidazoline wherein R¹ is an acyclic aliphatic C₁₅-C₁₇ hydrocarbon group, R² is an ethylene group, and G is a NH group.

A non-limiting example of Compound (6) is the reaction products of fatty acids with diethylenetriamine in a molecular ratio of about 2:1, said reaction product mixture containing N,N″-dialkyldiethylenetriamine with the formula:
R¹—C(O)—NH—CH₂CH₂—NH—CH₂CH₂—NH—C(O)—R¹
wherein R¹—C(O) is an alkyl group of a commercially available fatty acid derived from a vegetable or animal source, such as Emersol® 223LL or Emersol® 7021, available from Henkel Corporation, and R² and R³ are divalent ethylene groups.

A non-limiting example of Compound (7) is a difatty amidoamine based softener having the formula:
[R¹—C(O)—NH—CH₂CH₂—N(CH₃)(CH₂CH₂OH)—CH₂CH₂—NH—C(O)—R¹]⁺CH₃SO₄—
wherein R¹—C(O) is an alkyl group, available commercially from the Witco Corporation e.g. under the trade name Varisoft® 222LT.

An example of Compound (8) is the reaction products of fatty acids with N-2-hydroxyethylethylenediamine in a molecular ratio of about 2:1, said reaction product mixture containing a compound of the formula:
R¹—C(O)—NH—CH₂CH₂—N(CH₂CH₂OH)—C(O)—R¹
wherein R¹—C(O) is an alkyl group of a commercially available fatty acid derived from a vegetable or animal source, such as Emersol® 223LL or Emersol® 7021, available from Henkel Corporation.

An example of Compound (9) is the diquaternary compound having the formula: 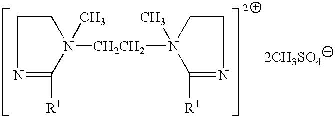
wherein R¹ is derived from fatty acid, and the compound is available from Witco Company.

It will be understood that combinations of softener actives disclosed above are suitable for use in this invention.

Anion A

In the cationic nitrogenous salts herein, the anion A⁻, which is any softener compatible anion, provides electrical neutrality. Most often, the anion used to provide electrical neutrality in these salts is from a strong acid, especially a halide, such as chloride, bromide, or iodide. However, other anions can be used, such as methylsulfate, ethylsulfate, acetate, formate, sulfate, carbonate, and the like. Chloride and methylsulfate are preferred herein as anion A. The anion can also, but less preferably, carry a double charge in which case A⁻ represents half a group.

B. Suds Suppressing System

In a preferred embodiment of the invention, the reduction of the suds is achieved by use of a suds suppressing system. The suds suppressing system is preferably present at a level of from about 0.01% to about 10%, more preferably from about 0.02% to about 5%, most preferably from about 0.05% to about 2% by weight of the composition. Such suds suppressing systems are even more desired components of the compositions of the invention when the detergent liquor is made of detergent which comprises a surfactant system that comprises high foaming surfactant, such as the conventional C₁₁-C₁₈ alkyl benzene sulfonates (“LAS”).

A wide variety of materials may be used as suds suppressers, and suds suppressers are well known to those skilled in the art. See, for example, Kirk Othmer Encyclopedia of Chemical Technology, Third Edition, Volume 7, pages 430-447 (John Wiley & Sons, Inc., 1979).

Suitable suds suppressing systems for use herein may comprise essentially any known antifoam compound, including, for example silicone antifoam compounds, alcohol antifoam compounds like 2-alkyl alcanol antifoam compounds, fatty acids, paraffin antifoam compounds, and mixtures thereof.

By antifoam compound it is meant herein any compound or mixtures of compounds which act such as to depress the foaming or sudsing produced by a solution of a detergent composition, particularly in the presence of agitation of that solution.

Particularly preferred antifoam compounds for use herein are silicone antifoam compounds defined herein as any antifoam compound including a silicone component. Such silicone antifoam compounds also typically contain a silica component. The term “silicone” as used herein, and in general throughout the industry, encompasses a variety of relatively high molecular weight polymers containing siloxane units and hydrocarbyl group of various types like the polyorganosiloxane oils, such as polydimethyl-siloxane, dispersions or emulsions of polyorganosiloxane oils or resins, and combinations of polyorganosiloxane with silica particles wherein the polyorganosiloxane is chemisorbed or fused onto the silica. Silicone suds suppressers are well known in the art and are, for example, disclosed in U.S. Pat. No. 4,265,779, issued May 5, 1981 to Gandolfo et al and European Patent Application No. 89307851.9, published Feb. 7, 1990, by Starch, M. S. Other silicone suds suppressers are disclosed in U.S. Pat. No. 3,455,839 which relates to compositions and processes for defoaming aqueous solutions by incorporating therein small amounts of polydimethylsiloxane fluids. Mixtures of silicone and silanated silica are described, for instance, in German Patent Application DOS 2,124,526. Silicone defoamers and suds controlling agents in granular detergent compositions are disclosed in U.S. Pat. No. 3,933,672, Bartolotta et al, and in U.S. Pat. No. 4,652,392, Baginski et al, issued Mar. 24, 1987.

Examples of suitable silicone antifoam compounds are the combinations of polyorganosiloxane with silica particles commercially available from Dow Corning, Wacker Chemie and General Electric.

Other suitable antifoam compounds include the monocarboxylic fatty acids and soluble salts thereof. These materials are described in U.S. Pat. No. 2,954,347, issued Sep. 27, 1960 to Wayne St. John. The monocarboxylic fatty acids, and salts thereof, for use as suds suppressing system typically have hydrocarbyl chains of about 10 to about 24 carbon atoms, preferably about 12 to about 18 carbon atoms like the tallow amphopolycarboxyglycinate commercially available under the trade name TAPAC. Suitable salts include the alkali metal salts such as sodium, potassium, and lithium salts, and ammonium and alkanolammonium salts.

Other suitable antifoam compounds include, for example, high molecular weight hydrocarbons such as paraffin, light petroleum odorless hydrocarbons, fatty esters (e.g. fatty acid triglycerides, glyceryl derivatives, polysorbates), fatty acid esters of monovalent alcohols, aliphatic C₁₈-C₄₀ ketones (e.g. stearone) N-alkylated amino triazines such as tri- to hexa-alkylmelamines or di- to tetra alkyldiamine chlortriazines formed as products of cyanuric chloride with two or three moles of a primary or secondary amine containing 1 to 24 carbon atoms, propylene oxide, bis stearic acid amide and monostearyl phosphates such as monostearyl alcohol phosphate ester and monostearyl di-alkali metal (e.g., K, Na, and Li) phosphates and phosphate esters, and nonionic polyhydroxyl derivatives. The hydrocarbons, such as paraffin and haloparaffin, can be utilized in liquid form. The liquid hydrocarbons will be liquid at room temperature and atmospheric pressure, and will have a pour point in the range of about −40° C. and about 5° C., and a minimum boiling point not less than about 110° C. (atmospheric pressure). It is also known to utilize waxy hydrocarbons, preferably having a melting point below about 100° C. Hydrocarbon suds suppressers are described, for example, in U.S. Pat. No. 4,265,779, issued May 5, 1981 to Gandolfo et al. The hydrocarbons, thus, include aliphatic, alicyclic, aromatic, and heterocyclic saturated or unsaturated hydrocarbons having from about 12 to about 70 carbon atoms. The term “paraffin”, as used in this suds suppresser discussion, is intended to include mixtures of true paraffins and cyclic hydrocarbons.

Copolymers of ethylene oxide and propylene oxide, particularly the mixed ethoxylated/propoxylated fatty alcohols with an alkyl chain length of from about 10 to about 16 carbon atoms, a degree of ethoxylation of from about 3 to about 30 and a degree of propoxylation of from about 1 to about 10, are also suitable antifoam compounds for use herein.

Other suds suppressers useful herein comprise the secondary alcohols (e.g., 2-alkyl alkanols as described in DE 40 21 265) and mixtures of such alcohols with silicone oils, such as the silicones disclosed in U.S. Pat. Nos. 4,798,679, 4,075,118 and EP 150,872. The secondary alcohols include the C₆-C₁₆ alkyl alcohols having a C₁-C₁₆ chain like the 2-Hexyldecanol commercially available under the trade name ISOFOL16, 2-Octyldodecanol commercially available under the tradename ISOFOL20, and 2-butyl octanol, which is available under the trademark ISOFOL 12 from Condea. A preferred alcohol is 2-butyl octanol, which is available from Condea under the trademark ISOFOL 12. Mixtures of secondary alcohols are available under the trademark ISALCHEM 123 from Enichem. Mixed suds suppressers typically comprise mixtures of alcohol to silicone at a weight ratio of about 1:5 to about 5:1.

Other suitable antifoams, described in the literature such as in Hand Book of Food Additives, ISBN 0-566-07592-X, p. 804, are selected from dimethicone, poloxamer, polypropyleneglycol, tallow derivatives, and mixtures thereof.

Preferred among the suds suppressing systems described above are the silicone antifoams, in particular the combinations of polyorganosiloxane with silica particles.

C. Surfactant Scavenger

The preferred surfactant scavengers of the present invention preferably include monoalkyl quaternary ammonium compounds and amine precursors thereof, polyvinyl amines, polyquaternary ammonium compounds and amine precursors thereof.

1. Monoalkyl Quaternary Ammonium Compounds

A preferred composition of the present invention comprises at least about 0.5%, preferably from about 0.5% to about 5%, more preferably from about 1% to about 20% by weight, of a scavenger having the formula:
a) A first type of scavenger having the general formula:
   {R₃—N^{+—[(CH}₂)ₙ—Y—R¹} X⁻
   wherein each R substituent is independently either hydrogen, a short chain C₁-C₆, preferably C₁-C₃ alkyl or hydroxyalkyl group, e.g., methyl, ethyl, propyl, hydroxyethyl, and the like, poly (C₂₋₃ alkoxy), preferably polyethoxy, benzyl, or mixtures thereof; each n is from 1 to about 4, preferably 2; each Y is —O—(O)C—, —C(O)—O—, —NR—C(O)—, or —C(O)—NR—; the sum of carbons in each R¹, plus one when Y is —O—(O)C— or —NR—C(O)—, is C₈-C₂₂, preferably C₈-C₂₀, with each R¹ being a hydrocarbyl, or substituted hydrocarbyl group, and X⁻ can be any softener-compatible anion, preferably, chloride, bromide, methylsulfate, ethylsulfate, sulfate, and nitrate, more preferably chloride or methyl sulfate;
b) A second type of scavenger having the general formula:
   [R₃N⁺CH₂CH(YR¹)(CH₂YR¹)] X⁻
   wherein each Y, R, R¹, and X⁻ have the same meanings as before and wherein one YR¹═OH. Such compounds include those having the formula:
   [CH₃]₃N⁽⁺⁾[CH₂CH(CH₂OH)O(O)CR¹] Cl^{(-) or}
   [CH₃]₃N⁽⁺⁾[CH₂CH(CH₂O(O)C R¹)OH] Cl⁽⁻⁾
   wherein each R is a methyl or ethyl group and preferably each R¹ is in the range of C₇ to C₁₉.
c) scavengers having the formula:
   [R₃—N⁺—R¹] X⁻
   wherein each R, R¹, and X⁻ have the same meanings as before.
d) scavenger having the formula: 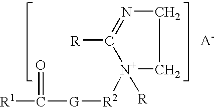
   wherein each R, R¹ and A⁻ have the definitions given above; each R² is a C₁₋₆ alkylene group, preferably an ethylene group; and G is an oxygen atom or an —NR— group. or 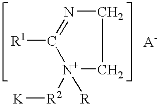
   wherein each R, R¹ and A⁻ have the definitions given above; each R² is a C₁₋₆ alkylene group, preferably an ethylene group; and K is an OH or an —NR₂ group.
e) scavenger having the formula: 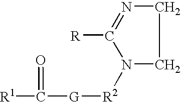
   wherein R, R¹, R² and G are defined as above; or 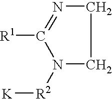
   wherein R¹,R² and K are defined as above.
f) reaction products of fatty acids with dialkylenetriamines in, e.g., a molecular ratio of about 1:1, said reaction products containing compounds of the formula:
   R¹—C(O)—NH—R²—NH—R³—NH—C(O)—R
   wherein R, R¹, R² are defined as above, and each R³ is a C₁₋₆ alkylene group, preferably an ethylene group such as diethylenetriamine or N-hydroxyethyl ethylenediamine. Such reaction products may optionally be quaternized by addition of an alkylation agent such as dimethyl sulfate. Quaternized reaction products are described in additional detail in U.S. Pat. No. 5,296,622, issued Mar. 22, 1994 to Uphues et al., which is incorporated herein by reference;
g) scavenger having the formula:
   [R¹—C(O)—NR—R²—N(R)₂—R³—NR—C(O)—R]⁺ A⁻
   wherein R, R¹, R², R³ and A⁻ are defined as above;
h) the reaction product of fatty acid with hydroxyalkylalkylenediamines in a molecular ratio of about 1:1, said reaction products containing compounds of the formula:
   R¹—C(O)—NH—R²—N(R³OH)—C(O)—R
   wherein R, R¹, R² and R³ are defined as above;
i) scavenger having the formula:

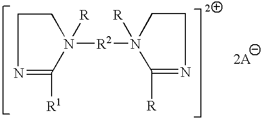

wherein R, R¹, R², and A⁻ are defined as above.

Where the fabric softener used in the compositions of the present invention is a dialkyl substituted quaternary ammonium compound and the surfactant scavenger is a monoalkyl quaternary ammonium compound, it is preferred that the fabric softening active and surfactant scavenger be prepared together from the same starting materials via standard reaction chemistry. Where the fabric softening active is a reaction product of fatty acids and oligamines, the mole ratio of fatty acid to amine is less than about 2:1, preferably between about 1.6:1 to about 0.8:1, and more preferably between about 1.6:1 and about 1:1, to obtain a mixture of mono- and dialkyl substituted compounds. More generally, by selecting a monoalkyl quaternary ammonium compound that is a variant of the fabric softening active compound, the final composition is less likely to experience phase separation. Not to be bound by theory, but it has been observed that the monoalkyl quaternary ammonium compound can have a tendency to form micelles in the finished product. By selecting a monoalkyl quaternary ammonium compound that is compatible with or a variant of the fabric softening active, the tendency of the monoalkyl quaternary ammonium compound to form micelles and thereby induce separation is significantly reduced. Therefore, it is preferred that the fabric softening actives and surfactant scavengers used in the compositions of the present invention be synthesized in a common reaction from the same starting materials.

It will be understood that all combinations of scavenger structures disclosed above are suitable for use in this invention.

Anion A

In the cationic nitrogenous salts herein, the anion A⁻, which is any softener compatible anion, provides electrical neutrality. Most often, the anion used to provide electrical neutrality in these salts is from a strong acid, especially a halide, such as chloride, bromide, or iodide. However, other anions can be used, such as methylsulfate, ethylsulfate, acetate, formate, sulfate, carbonate, and the like. Chloride and methylsulfate are preferred herein as anion A. The anion can also, but less preferably, carry a double charge in which case A⁻ represents half a group.

2. Polyvinyl Amines

A preferred composition according to the present invention contains at least about 0.2%, preferably from about 0.2% to about 5%, more preferably from about 0.2% to about 20% by weight, of one or more polyvinyl amines having the formula 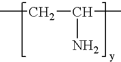
wherein y is from about 3 to about 10,000, preferably from about 10 to about 5,000, more preferably from about 20 to about 500. Polyvinyl amines suitable for use in the present invention are available from BASF.

Optionally, one or more of the polyvinyl amine backbone —NH₂ unit hydrogens can be substituted by an acyl group having the formula —(C(O)—R)— where R is as defined as above or an alkyleneoxy unit having the formula:
—(R¹O)ₓR²
wherein R¹ is C₂-C₄ alkylene, R² is hydrogen, C₁-C₄ alkyl, and mixtures thereof; x is from 1 to 50. In one embodiment or the present invention the polyvinyl amine is reacted first with a substrate which places a 2-propyleneoxy unit directly on the nitrogen followed by reaction of one or more moles of ethylene oxide to form a unit having the general formula: 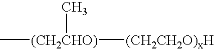
wherein x has the value of from about 1 to about 50. Substitutions such as the above are represented by the abbreviated formula PO—EOₓ—. However, more than one propyleneoxy unit can be incorporated into the alkyleneoxy substituent.

3. Poly-Quaternary Ammonium Compounds and Amine Precursors Thereof.

A preferred composition of the present invention comprises at least about 0.2%, preferably from about 0.2% to about 5%, more preferably from about 0.5% to about 10% by weight, of a scavenger having the formula: 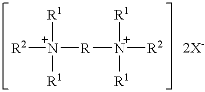
wherein R is substituted or unsubstituted C₂-C₁₂ alkylene, substituted or unsubstituted C₂-C₁₂ hydroxyalkylene; each R¹ is independently C₁-C₄ alkyl, C1-C4 hydroxyalkyl or hydrogen, each R² is independently C₁-C₂₂ alkyl, C₃-C₂₂ alkenyl, hydrogen, R⁵—Y—(CH₂)ₘ-, wherein R⁵ is C₁-C₂₂ alkyl, C₃-C₂₂ alkenyl, and mixtures thereof; m is from 1 to about 6; each Y is —O—(O)C—, —C(O)—O—, —NR—C(O)—, or —C(O)—NR—; X is an anion.

Preferably R is ethylene or propylene; R¹ is methyl or ethyl, more preferably methyl; at least one R² is preferably C₁-C₄ alkyl, more preferably methyl. Preferably at least one R² is C₁₁-C₂₂ alkyl, C₁₁-C₂₂ alkenyl, and mixtures thereof.

The formulator may similarly choose R² to be a R⁵—Y—(CH₂)ₘ- moiety wherein R⁵ is an alkyl moiety having from 1 to 22 carbon atoms, preferably the alkyl moiety when taken together with the Y unit is an acyl unit derived preferably from a source of triglyceride selected from the group consisting of tallow, (partially) hydrogenated tallow, lard, (partially) hydrogenated lard, vegetable oils and/or (partially) hydrogenated vegetable oils, such as, coconut oil, palm oil, canola oil, safflower oil, peanut oil, sunflower oil, corn oil, soybean oil, tall oil, rice bran oil, etc. and mixtures thereof.

An example of a polyquaternary ammonium scavenger comprising a R⁵—Y—(CH₂)ₘ- moiety has the formula: 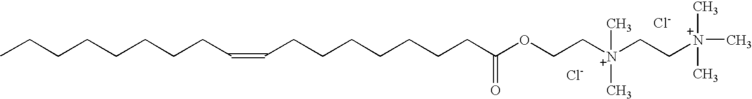
wherein R¹ is methyl, one R² units is methyl and the other R² unit is R⁵—Y—(CH₂)ₘ— wherein R⁵—Y— is an oleoyl unit and m is equal to 2.

Another non-limiting example is the following: 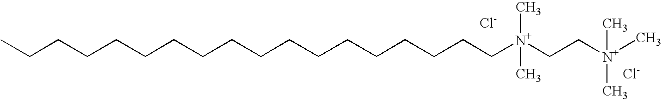
wherein X⁻ is a softener compatible anion, preferably the anion of a strong acid, for example, chloride, bromide, methylsulfate, ethylsulfate, sulfate, nitrate and mixtures thereof, more preferably chloride and methyl sulfate.

In a preferred embodiment of the present invention, the surfactant scavenger is the monoalkyl variant of the softener active present. The surfactant scavenger and softener active are prepared from the same starting materials via standard reaction chemistry by adjusting the ratio fatty acid to amine to obtain the preferred mixture of monoalkylsubstituted (scavenger) and dialkylsubstituted (softener active) compounds. Non-limiting examples of such compounds are the reaction products of fatty acid with methyl diethanolamine in a ratio between about 2:1 and about 1:1, quaternized with methyl chloride, resulting in a mixture of N,N-bis(stearoyl-oxy-ethyl) N,N-dimethyl ammonium chloride and N-(stearoyl-oxy-ethyl) N,-hydroxyethyl N,N dimethyl ammonium chloride. This compound is referred to as LF-DEEDMAC.

D. Optional Adjunct Ingredients

1. Dispersing Agents

The fabric conditioning compositions of the present invention may comprise an optional dispersant for suspending materials in the rinse and inhibiting their deposition on the laundered fabrics. Dispersing agents can advantageously be utilized at levels from about 0% to about 7%, more preferably from about 0.1% to about 5%, and even more preferably from about 0.2% to about 3% by weight, in the compositions described herein. Preferably, the optional dispersing agent will be substantially water soluble.

Suitable nonionic surfactants to serve as the dispersing agent include addition products of ethylene oxide and, optionally, propylene oxide, with fatty alcohols, fatty acids, fatty amines, etc. They are referred to herein as ethoxylated fatty alcohols, ethoxylated fatty acids, and ethoxylated fatty amines. Any of the ethoxylated materials of the particular type described hereinafter can be used as the nonionic surfactant. Suitable compounds are surfactants of the general formula:
R¹—Y—(C₂H₄O)_{z}—C₂H₄OH
wherein R¹ is selected from the group consisting of primary, secondary and branched chain alkyl and/or acyl and/or acyl hydrocarbyl groups; primary, secondary and branched chain alkenyl hydrocarbyl groups, and primary, secondary and branched chain alkyl- and alkenyl substituted phenolic hydrocarbyl groups; said hydrocarbyl groups having a hydrocarbyl chain length of from about 8 to about 20, preferably from about 9 to about 18 carbon atoms. In the general formula for the ethoxylated nonionic surfactants herein Y is typically —O—, —C(O)O—, preferably —O—, and in which R¹, when present, have the meanings given hereinbefore, and z is preferably at least about 4, more preferably about 7 to about 25.

Also suited are compounds having the general formula:
R¹O(CH(R²)CH₂O)ₓ(CH₂CH₂O)_{y}R³ or R¹O(CH₂CH₂O)ₓ(CH(R²)CH₂O)_{y}R³
wherein R¹ is defined as above; R² is a C₁-C₃ alkyl unit; and R³ is hydrogen or C₁-C₃ alkyl. The individual alkoxy monomers can be arranged blockwise or randomly. Non-limiting examples are the Plurafac surfactants from BASF.

Also suited as dispersing agent are the so-called Propyleneoxide/ethyleneoxide block copolymers, having the following general structure:
HO(CH₂CH₂O)ₓ(CH(CH₃)CH₂O)_{y}(CH₂CH₂O)_{z}H
Non-limiting examples are the Pluronic PE compounds from BASF.

2. Stabilizers

In the presence of antifoam materials made of silicone, it is preferred to use a component that will provide a good stabilization of the silicone antifoam and hence of the composition. Typical levels of stabilizing agents are of from about 0.01% to about 20%, preferably from about 0.05% to about 8%, more preferably from about 0.1% to about 6% by weight of the composition.

Suitable stabilizing agents to be used herein include synthetic and naturally occurring polymers. Suitable stabilizing agents for use herein include xanthan gum or derivatives thereof, alginate or a derivative thereof, polysaccharide polymers such as substituted cellulose materials like ethoxylated cellulose, carboxymethylcellulose, hydroxymethylcellulose, hydroxypropyl cellulose, hydroxyethyl cellulose and mixtures thereof. Xanthan gum is a particularly preferred stabilizer.

Preferred stabilizing agents for use in the compositions of the invention are xanthan gum or derivatives thereof sold by the Kelco Division of Merck under the trade names KELTROL®, KELZAN AR®, KELZAN D35®, KELZAN S®, KELZAN XZ® and the like.

Polymeric soil release agents are also useful in the present invention as stabilizing agents. These include cellulosic derivatives such as hydroxyether cellulosic polymers, ethoxylated cellulose, carboxymethylcellulose, hydroxymethylcellulose, hydroxypropyl cellulose, hydroxyethyl cellulose, and the like. Such agents are commercially available and include hydroxyethers of cellulose such as METHOCEL (Dow). Cellulosic soil release agents for use herein also include those selected from the group consisting of C1-C4 alkyl and C4 hydroxyalkyl cellulose; see U.S. Pat. No. 4,000,093, issued Dec. 28, 1976 to Nicol, et al.

3. pH Control Agents

The pH of the compositions may be adjusted by the use of various pH acidification agents. Preferred acidification agents include inorganic and organic acids including, for example, carboxylate acids, such as citric and succinic acids, Highly preferred acidification agents are inorganic acids such as hydrochloric acid and phosphoric acid. Such acidification agents will be used at levels needed to adjust the pH of the composition to a preferred level. Typically, the level of the acidification agent will be about 0.01% to about 0.02% by weight of the composition.

4. Metal Ion Control Agents

Heavy metal ion (HMI) sequestrants are useful components herein for optimum whiteness and HMI control. By heavy metal ion sequestrants it is meant components which act to sequester (chelate) heavy metal ions. These components may also have calcium and magnesium chelation capacity, but preferentially they bind heavy metal ions such as iron, manganese and copper. These compounds are even more desired when the water is a tap water of low quality and consequently that which comprises a high level of HMI.

Heavy metal ion sequestrants are preferably present at a level of from about 0.005% to about 20%, more preferably from about 0.1% to about 10%, most preferably from about 0.2% to about 5% by weight of the compositions.

Heavy metal ion sequestrants, which are acidic in nature, having for example phosphonic acid or carboxylic acid functionalities, may be present either in their acid form or as a complex/salt with a suitable counter cation such as an alkali or alkaline metal ion, ammonium, or substituted ammonium ion, or any mixtures thereof. Preferably any salts/complexes are water soluble. The molar ratio of said counter cation to the heavy metal ion sequestrant is preferably at least about 1:1.

Suitable heavy metal ion sequestrants for use herein include the organo aminophosphonates, such as the amino alkylene poly (alkylene phosphonates) and nitrilo trimethylene phosphonates. Preferred organo aminophosphonates are diethylene triamine penta (methylene phosphonate) and hexamethylene diamine tetra (methylene phosphonate).

Other suitable heavy metal ion sequestrants for use herein include nitrilotriacetic acid and polyaminocarboxylic acids such as ethylenediaminotetracetic acid, ethylenetriamine pentacetic acid, or ethylenediamine disuccinic acid. A further suitable material is ethylenediamine-N,N′-disuccinic acid (EDDS), most preferably present in the form of its S,S isomer, which is preferred for its biodegradability profile.

Still other suitable heavy metal ion sequestrants for use herein are iminodiacetic acid derivatives such as 2-hydroxyethyl diacetic acid or glyceryl imino diacetic acid, described in EPA 317 542 and EPA 399 133.

5. Colorants & Brighteners
a) Dyes

The compositions of the present invention may optionally contain a dye or other colorant to improve the aesthetics of the composition. When present, a dye will preferably comprise less than about 0.005% by weight of the composition, and even more preferably less than about 0.002%. Dyes are well known in the art and are available from a variety of commercial sources.
b) Brighteners

Commercial optical brighteners which may be useful in the present invention can be classified into subgroups, which include, but are not necessarily limited to, derivatives of stilbene, pyrazoline, coumarin, carboxylic acid, methinecyanines, dibenzothiphene-5,5-dioxide, azoles, 5- and 6-membered-ring heterocycles, and other miscellaneous agents. Examples of such brighteners are disclosed in “The Production and Application of Fluorescent Brightening Agents”, M. Zahradnik, Published by John Wiley & Sons, New York (1982).

Specific examples of optical brighteners which are useful in the present compositions are those identified in U.S. Pat. No. 4,790,856, issued to Wixon on Dec. 13, 1988. These brighteners include the PHORWHITE series of brighteners from Verona. Other brighteners disclosed in this reference include: Tinopal UNPA, Tinopal CBS and Tinopal 5BM; available from Ciba-Geigy; Artic White CC and Artic White CWD, available from Hilton-Davis, located in Italy; the 2-(4-stryl-phenyl)-2H-napthol[1,2-d]triazoles; 4,4′-bis-(1,2,3-triazol-2-yl)-stilbenes; 4,4′-bis(stryl)bisphenyls; and the aminocoumarins. Specific examples of these brighteners include 4-methyl-7-diethyl-amino coumarin; 1,2-bis(-venzimidazol-2-yl)ethylene; 1,3-diphenyl-phrazolines; 2,5-bis(benzoxazol-2-yl)thiophene; 2-stryl-napth-[1,2-d]oxazole; and 2-(stilbene-4-yl)-2H-naphtho-[1,2-d]triazole. See also U.S. Pat. No. 3,646,015, issued Feb. 29, 1972 to Hamilton. Anionic brighteners are preferred herein.

More specifically, the hydrophilic optical brighteners useful in the present invention are those having the structural formula: 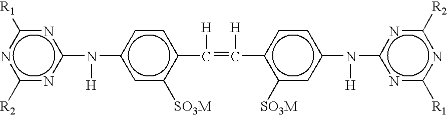
wherein R₁ is selected from anilino, N-2-bis-hydroxyethyl and NH-2-hydroxyethyl; R₂ is selected from N-2-bis-hydroxyethyl, N-2-hydroxyethyl-N-methylamino, morphilino, chloro and amino; and M is a salt-forming cation such as sodium or potassium.

When in the above formula, R₁ is anilino, R₂ is N-2-bis-hydroxyethyl and M is a cation such as sodium, the brightener is 4,4′,-bis[(4-anilino-6-(N-2-bis-hydroxyethyl)-s-triazine-2-yl)amino]-2,2′-stilbenedisulfonic acid and disodium salt. This particular brightener species is commercially marketed under the trade name Tinopal-UNPA-GX® by Ciba-Geigy Corporation. Tinopal-UNPA-GX is the preferred hydrophilic optical brightener useful in the rinse added compositions herein.

When in the above formula, R₁ is anilino, R₂ is N-2-hydroxyethyl-N-2-methylamino and M is a cation such as sodium, the brightener is 4,4′-bis[(4-anilino-6-(N-2-hydroxyethyl-N-methylamino)-s-triazine-2-yl)amino]2,2′-stilbenedisulfonic acid disodium salt. This particular brightener species is commercially marketed under the tradename Tinopal 5BM-GX® by Ciba-Geigy Corporation.

When in the above formula, R₁ is anilino, R₂ is morphilino and M is a cation such as sodium, the brightener is 4,4′-bis[(4-anilino-6-morphilino-s-triazine-2-yl)amino]2,2′-stilbenedisulfonic acid, sodium salt. This particular brightener species is commercially marketed under the tradename Tinopal AMS-GX® by Ciba Geigy Corporation.

6. Odor Control Agent

Materials for use in odor control may be of the type disclosed in U.S. Pat. Nos. 5,534,165; 5,578,563; 5,663,134; 5,668,097; 5,670,475; and 5,714,137, Trinh et al. issued Jul. 9, 1996; Nov. 26, 1996; Sep. 2, 1997; Sep. 16, 1997; Sep. 23, 1997; and Feb. 3, 1998 respectively, all of said patents being incorporated herein by reference. Such compositions can contain several different optional odor control agents.
a) Pro-Perfumes

A pro-perfume may be useful in order to mask malodor. A pro-perfume is defined as a perfume precursor that releases a desirable odor and/or perfume molecule through the breaking of a chemical bond. Typically to form a pro-perfume, a desired perfume raw material is chemically linked with a carrier, preferably a slightly volatile or a sparingly volatile carrier. The combination results in a less volatile and more hydrophobic pro-perfume which results in increased deposition onto the fabric article. The perfume is then released by breaking the bond between the perfume raw material and the carrier either through a change in pH (e.g., due to perspiration during wear), air moisture, heat, enzymatic action and/or sunlight during storage or line drying. Thus, malodor is effectively masked by the release of the perfume raw material.

A perfume raw material for use in pro-perfumes are typically saturated or unsaturated, volatile compounds which contain an alcohol, an aldehyde, and/or a ketone group. The perfume raw materials useful herein include any fragrant substance or mixture of substances including natural (i.e., obtained by extraction of flowers, herbs, leaves, roots, barks, wood, blossoms or plants), artificial (i.e., a mixture of different nature oils or oil constituents) and synthetic (i.e., synthetically produced) odoriferous substances. Such materials are often accompanied by auxiliary materials, such as fixatives, extenders, stabilizers and solvents. These auxiliaries are also included within the meaning of “perfume”, as used herein. Typically, perfumes are complex mixtures of a plurality of organic compounds.
b) Cyclodextrin

As used herein, the term “cyclodextrin” includes any of the known cyclodextrins such as unsubstituted cyclodextrins containing from six to twelve glucose units, especially, alpha-cyclodextrin, beta-cyclodextrin, gamma-cyclodextrin and/or their derivatives and/or mixtures thereof. The alpha-cyclodextrin consists of six glucose units, the beta-cyclodextrin consists of seven glucose units, and the gamma-cyclodextrin consists of eight glucose units arranged in donut-shaped rings. The specific coupling and conformation of the glucose units give the cyclodextrins rigid, conical molecular structures with hollow interiors of specific volumes. The “lining” of each internal cavity is formed by hydrogen atoms and glycosidic bridging oxygen atoms; therefore, this surface is fairly hydrophobic. The unique shape and physical-chemical properties of the cavity enable the cyclodextrin molecules to absorb (form inclusion complexes with) organic molecules or parts of organic molecules which can fit into the cavity. Many odorous molecules can fit into the cavity including many malodorous molecules and perfume molecules. Therefore, cyclodextrins, and especially mixtures of cyclodextrins with different size cavities, can be used to control odors caused by a broad spectrum of organic odoriferous materials, which may, or may not, contain reactive functional groups.

The complexing between cyclodextrin and odorous molecules occurs rapidly in the presence of water. However, the extent of the complex formation also depends on the polarity of the absorbed molecules. In an aqueous solution, strongly hydrophilic molecules (those which are highly water-soluble) are only partially absorbed, if at all. Therefore, cyclodextrin does not complex effectively with some very low molecular weight organic amines and acids when they are present at low levels. As the water is being removed however, e.g., the fabric is being dried off, some low molecular weight organic amines and acids have more affinity and will complex with the cyclodextrins more readily.

Cyclodextrins that are useful in the present invention are highly water-soluble such as, alpha-cyclodextrin and/or derivatives thereof, gamma-cyclodextrin and/or derivatives thereof, derivatised beta-cyclodextrins, and/or mixtures thereof. The derivatives of cyclodextrin consist mainly of molecules wherein some of the OH groups are converted to OR groups. Cyclodextrin derivatives include, e.g., those with short chain alkyl groups such as methylated cyclodextrins, and ethylated cyclodextrins, wherein R is a methyl or an ethyl group; those with hydroxyalkyl substituted groups, such as hydroxypropyl cyclodextrins and/or hydroxyethyl cyclodextrins, wherein R is a —CH₂—CH(OH)—CH₃ or a —CH₂CH₂—OH group; branched cyclodextrins such as maltose-bonded cyclodextrins; cationic cyclodextrins such as those containing 2-hydroxy-3-(dimethylamino)propyl ether, wherein R is CH₂—CH(OH)—CH₂—N(CH₃)₂ which is cationic at low pH; quaternary ammonium, e.g., 2-hydroxy-3-(trimethylammonio)propyl ether chloride groups, wherein R is CH₂—CH(OH)—CH₂—N⁺(CH₃)₃Cl⁻; anionic cyclodextrins such as carboxymethyl cyclodextrins, cyclodextrin sulfates, and cyclodextrin succinylates; amphoteric cyclodextrins such as carboxymethyl/quaternary ammonium cyclodextrins; cyclodextrins wherein at least one glucopyranose unit has a 3-6-anhydro-cyclomalto structure, e.g., the mono-3-6-anhydrocyclodextrins, as disclosed in “Optimal Performances with Minimal Chemical Modification of Cyclodextrins”, F. Diedaini-Pilard and B. Perly, The 7th International Cyclodextrin Symposium Abstracts, Apr. 1994, p. 49, said references being incorporated herein by reference; and mixtures thereof. Other cyclodextrin derivatives are disclosed in U.S. Pat. Nos. 3,426,011; 3,453,257; 3,453,258; 3,453,259; 3,453,260; 3,459,731; 3,553,191; 3,565,887; 4,535,152; 4,616,008; 4,678,598; 4,638,058; and 4,746,734.

Highly water-soluble cyclodextrins are those having water solubility of at least about 10 g in 100 ml of water at room temperature, preferably at least about 20 g in 100 ml of water, more preferably at least about 25 g in 100 ml of water at room temperature. The availability of solubilized, uncomplexed cyclodextrins is essential for effective and efficient odor control performance. Solubilized, water-soluble cyclodextrin can exhibit more efficient odor control performance than non-water-soluble cyclodextrin when deposited onto surfaces, especially fabric.

Examples of preferred water-soluble cyclodextrin derivatives suitable for use herein are hydroxypropyl alpha-cyclodextrin, methylated alpha-cyclodextrin, methylated beta-cyclodextrin, hydroxyethyl beta-cyclodextrin, and hydroxypropyl beta-cyclodextrin. Hydroxyalkyl cyclodextrin derivatives preferably have a degree of substitution of from about 1 to about 14, more preferably from about 1.5 to about 7, wherein the total number of OR groups per cyclodextrin is defined as the degree of substitution. Methylated cyclodextrin derivatives typically have a degree of substitution of from about 1 to about 18, preferably from about 3 to about 16. A known methylated beta-cyclodextrin is heptakis-2,6-di-O-methyl-β-cyclodextrin, commonly known as DIMEB, in which each glucose unit has about 2 methyl groups with a degree of substitution of about 14. A preferred, more commercially available, methylated beta-cyclodextrin is a randomly methylated beta-cyclodextrin, commonly known as RAMEB, having different degrees of substitution, normally of about 12.6. RAMEB is more preferred than DIMEB, since DIMEB affects the surface activity of the preferred surfactants more than RAMEB. The preferred cyclodextrins are available, e.g., from Cerestar USA, Inc. and Wacker Chemicals (USA), Inc.

It is also preferable to use a mixture of cyclodextrins. Such mixtures absorb odors more broadly by complexing with a wider range of odoriferous molecules having a wider range of molecular sizes. Preferably at least a portion of the cyclodextrins is alpha-cyclodextrin and its derivatives thereof, gamma-cyclodextrin and its derivatives thereof, and/or derivatised beta-cyclodextrin, more preferably a mixture of alpha-cyclodextrin, or an alpha-cyclodextrin derivative, and derivatised beta-cyclodextrin, even more preferably a mixture of derivatised alpha-cyclodextrin and derivatised beta-cyclodextrin, most preferably a mixture of hydroxypropyl alpha-cyclodextrin and hydroxypropyl beta-cyclodextrin, and/or a mixture of methylated alpha-cyclodextrin and methylated beta-cyclodextrin.
c) Perfume

As used herein the term “perfume” is used to indicate any odoriferous material that is subsequently released into the aqueous rinse bath solution and/or onto fabrics contacted therewith. The perfume will most often be liquid at ambient temperatures. A wide variety of chemicals are known for perfume uses, including materials such as aldehydes, ketones, and esters. More commonly, naturally occurring plant and animal oils and exudates comprising complex mixtures of various chemical components are known for use as perfumes. The perfumes herein can be relatively simple in their compositions or can comprise highly sophisticated complex mixtures of natural and synthetic chemical components, all chosen to provide any desired odor. Typical perfumes can comprise, for example, woody/earthy bases containing exotic materials such as sandalwood, civet and patchouli oil. The perfumes can be of a light floral fragrance, e.g. rose extract, violet extract, and lilac. The perfumes can also be formulated to provide desirable fruity odors, e.g. lime, lemon, and orange. Further, it is anticipated that so-called “designer fragrances” that are typically applied directly to the skin may be used in the compositions of the present invention. Likewise, the perfumes may be selected for an aromatherapy effect, such as providing a relaxing or invigorating mood. As such, any material that exudes a pleasant or otherwise desirable odor can be used as a perfume active in the compositions of the present invention.
d) Mixtures Thereof

Mixtures of the optional odor control agents described above are desirable, especially when the mixture provides control over a broader range of odors.

7. Solvents

Another optional, but preferred, ingredient is a liquid carrier. The liquid carrier employed in the instant compositions is preferably at least primarily water due to its low cost, relative availability, safety, and environmental compatibility. The level of water in the liquid carrier is preferably at least about 50%, most preferably at least about 60%, by weight of the carrier. Mixtures of water and low molecular weight, e.g., <about 200, organic solvent, e.g., lower alcohols such as ethanol, propanol, isopropanol or butanol are useful as the carrier liquid. Low molecular weight alcohols include monohydric, dihydric (glycol, etc.) trihydric (glycerol, etc.), and higher polyhydric (polyols) alcohols.

8. Soil Release Polymers

A soil release agent may optionally be incorporated into the compositions. Preferably, such a soil release agent is a polymer. One type of preferred soil release agent is a copolymer having random blocks of ethylene terephthalate and polyethylene oxide (PEO) terephthalate. The molecular weight of this polymeric soil release agent is in the range of from about 25,000 to about 55,000. Descriptions of such copolymers and their uses are provided in U.S. Pat. No. 3,959,230 to Hays, issued May 25, 1976 and U.S. Pat. No. 3,893,929 to Basadur issued July 8, 1975.

Another preferred soil release polymer is a crystallizable polyester with repeating units of ethylene terephthalate containing from about 10% to about 15% by weight of ethylene terephthalate units together with from about 10% to about 50% by weight of polyoxyethylene terephthalate units that are derived from a polyoxyethylene glycol of average molecular weight of from about 300 to about 6,000. The molar ratio of ethylene terephthalate units to polyoxyethylene terephthalate units in such a crystallizable polymeric compound is between about 2:1 and about 6:1. Examples of this polymer include the commercially available materials Zelcon 4780® and Zelcon 5126 (from Dupont) and Milease T® (from ICI). See also U.S. Pat. No. 4,702,857, issued Oct. 27, 1987 to Gosselink.

Highly preferred soil release agents are polymers of the generic formula: 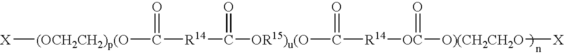
in which each X can be a suitable capping group, with each X typically being selected from the group consisting of H, and alkyl or acyl groups containing from about 1 to about 4 carbon atoms. p is selected for water solubility and generally is from about 6 to about 113, preferably from about 20 to about 50. u is critical to formulation in a liquid composition having a relatively high ionic strength. There should be very little material in which u is greater than 10. Furthermore, there should be at least about 20%, preferably at least about 40%, of material in which u ranges from about 3 to about 5.

The R¹⁴ moieties are essentially 1,4-phenylene moieties. As used herein, the term “the R¹⁴ moieties are essentially 1,4-phenylene moieties” refers to compounds where the R¹⁴ moieties consist entirely of 1,4-phenylene moieties, or are partially substituted with other arylene or alkarylene moieties, alkylene moieties, alkenylene moieties, or mixtures thereof. Arylene and alkarylene moieties which can be partially substituted for 1,4-phenylene include 1,3-phenylene, 1,2-phenylene, 1,8-naphthylene, 1,4-naphthylene, 2,2-biphenylene, 4,4-biphenylene, and mixtures thereof. Alkylene and alkenylene moieties which can be partially substituted include 1,2-propylene, 1,4-butylene, 1,5-pentylene, 1,6-hexamethylene, 1,7-heptamethylene, 1,8-octamethylene, 1,4-cyclohexylene, and mixtures thereof.

For the R¹⁴ moieties, the degree of partial substitution with moieties other than 1,4-phenylene should be such that the soil release properties of the compound are not adversely affected to any great extent. Generally the degree of partial substitution which can be tolerated will depend upon the backbone length of the compound, i.e., longer backbones can have greater partial substitution for 1,4-phenylene moieties. Usually, compounds where the R¹⁴ comprise from about 50% to about 100% 1,4-phenylene moieties (from 0% to about 50% moieties other than 1,4-phenylene) have adequate soil release activity. For example, polyesters made with a 40:60 mole ratio of isophthalic (1,3-phenylene) to terephthalic (1,4-phenylene) acid have adequate soil release activity. However, because most polyesters used in fiber making comprise ethylene terephthalate units, it is usually desirable to minimize the degree of partial substitution with moieties other than 1,4-phenylene for best soil release activity. Preferably, the R¹⁴ moieties consist entirely of (i.e., comprise about 100%) 1,4-phenylene moieties, i.e., each R¹⁴ moiety is 1,4-phenylene.

For the R¹⁵ moieties, suitable ethylene or substituted ethylene moieties include ethylene, 1,2-propylene, 1,2-butylene, 1,2-hexylene, 3-methoxy-1,2-propylene, and mixtures thereof. Preferably, the R¹⁵ moieties are essentially ethylene moieties, 1,2-propylene moieties, or mixtures thereof. Inclusion of a greater percentage of ethylene moieties tends to improve the soil release activity of compounds.

Surprisingly, inclusion of a greater percentage of 1,2-propylene moieties tends to improve the water solubility of compounds. Therefore, the use of 1,2-propylene moieties or a similar branched equivalent is desirable for incorporation of any substantial part of the soil release polymer where the fabric care composition will be added to a laundry solution containing fabric softening actives. Preferably, from about 75% to about 100%, are 1,2-propylene moieties.

The value for each p is at least about 6, and preferably is at least about 10. The value for each n usually ranges from about 12 to about 113. Typically the value for each p is in the range of from about 12 to about 43.

A more complete disclosure of soil release agents is contained in U.S. Pat. No. 4,018,569, Trinh, Gosselink and Rattinger, issued Apr. 4, 1989; U.S. Pat. No. 4,661,267, Decker, Konig, Straathof, and Gosselink, issued Apr. 28, 1987; U.S. Pat. No. 4,702,857, Gosselink, issued Oct. 27, 1987; U.S. Pat. No. 4,711,730, Gosselink and Diehl, issued Dec. 8, 1987; U.S. Pat. No. 4,749,596, Evans, Huntington, Stewart, Wolf, and Zimmerer, issued Jun. 7, 1988; U.S. Pat. No. 4,808,086, Evans, Huntington, Stewart, Wolf, and Zimmerer, issued Feb. 24, 1989; U.S. Pat. No. 4,818,569, Trinh, Gosselink, and Rattinger, issued Apr. 4, 1989; U.S. Pat. No. 4,877,896, Maldonado, Trinh, and Gosselink, issued Oct. 31, 1989; U.S. Pat. No. 4,956,447, Gosselink et al., issues Sep. 11, 1990; U.S. Pat. No. 4,968,451, Scheibel and Gosselink, issued Nov. 6, 1990; and U.S. Pat. No. 4,976,879, Maldonado, Trinh, and Gosselink, issued Dec. 11, 1990.

Polymeric soil release actives useful in the present invention may also include cellulosic derivatives such as hydroxyether cellulosic polymers, and the like. Such agents are commercially available and include hydroxyethers of cellulose such as METHOCEL (Dow). Cellulosic soil release agents for use herein also include those selected from the group consisting of C₁-C₄ alkyl and C₄ hydroxyalkyl cellulose; see U.S. Pat. No. 4,000,093, issued Dec. 28, 1976 to Nicol, et al.

Soil release agents characterized by poly(vinyl ester) hydrophobe segments include graft copolymers of poly(vinyl ester), e.g., C₁-C₆ vinyl esters, preferably poly(vinyl acetate) grafted onto polyalkylene oxide backbones, such as polyethylene oxide backbones. See European Patent Application 0 219 048, published Apr. 22, 1987 by Kud, et al. Commercially available soil release agents of this kind include the SOKALAN type of material, e.g., SOKALAN HP-22, available from BASF (Germany).

Still another preferred soil release agent is an oligomer with repeat units of terephthaloyl units, sulfoisoterephthaloyl units, oxyethyleneoxy and oxy-1,2-propylene units. The repeat units form the backbone of the oligomer and are preferably terminated with modified isethionate end-caps. A particularly preferred soil release agent of this type comprises about one sulfoisophthaloyl unit, 5 terephthaloyl units, oxyethyleneoxy and oxy-1,2-propyleneoxy units in a ratio of from about 1.7 to about 1.8, and two end-cap units of sodium 2-(2-hydroxyethoxy)-ethanesulfonate. Said soil release agent also comprises from about 0.5% to about 20%, by weight of the oligomer, of a crystalline-reducing stabilizer, preferably selected from the group consisting of xylene sulfonate, cumene sulfonate, toluene sulfonate, and mixtures thereof.

The compositions of the present invention may also contain soil release and anti-redeposition agents such as water-soluble ethoxylated amines, most preferably ethoxylated tetraethylenepentamine. Exemplary ethoxylated amines are further described in U.S. Pat. No. 4,597,898, VanderMeer, issued Jul. 1, 1986.

An hydrophobic dispersant is particularly suited for giving optimised stain removal benefit on clay. Accordingly, a preferred composition of the present invention comprises from about 0.1%, preferably from about 5%, more preferably form about 10% to about 80%, preferably to about 50%, more preferably to about 25% by weight, of a hydrophobic polyamine dispersant having the formula: 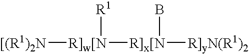
wherein R, R¹ and B are suitably described in U.S. Pat. No. 5,565,145 Watson et al., issued Oct. 15, 1996 incorporated herein by reference, and w, x, and y have values which provide for a backbone prior to substitution of preferably at least about 1200 daltons, more preferably 1800 daltons.
R¹ units are preferably alkyleneoxy units having the formula:
—(CH₂CHR′O)ₘ(CH₂CH₂O)ₙH
wherein R′ is methyl or ethyl, m and n are preferably from about 0 to about 50, provided the average value of alkoxylation provided by m+n is at least about 0.5.

9. Preservatives

Optionally, but preferably, antimicrobial preservative can be added to the compositions of the present invention, especially if the stabilizing agent is made of cellulose. Indeed, the cellulose materials can make a prime breeding ground for certain microorganisms, especially when in aqueous compositions. This drawback can lead to the problem of storage stability of the solutions for any significant length of time. Contamination by certain microorganisms with subsequent microbial growth can result in an unsightly and/or malodorous solution. Because microbial growth in solutions is highly objectionable when it occurs, it is highly preferable to include an antimicrobial preservative, which is effective for inhibiting and/or regulating microbial growth in order to increase storage stability of the composition.

It is preferable to use a broad spectrum preservative, e.g., one that is effective on both bacteria (both gram positive and gram negative) and fungi. A limited spectrum preservative, e.g., one that is only effective on a single group of microorganisms, e.g., fungi, can be used in combination with a broad spectrum preservative or other limited spectrum preservatives with complimentary and/or supplementary activity. A mixture of broad spectrum preservatives can also be used. In some cases where a specific group of microbial contaminants is problematic (such as Gram negatives), aminocarboxylate chelators, such as those described hereinbefore, can be used alone or as potentiators in conjunction with other preservatives. These chelators which include, e.g., ethylenediaminetetraacetic acid (EDTA), hydroxyethylenediaminetriacetic acid, diethylenetriaminepentaacetic acid, and other aminocarboxylate chelators, and mixtures thereof, and their salts, and mixtures thereof, can increase preservative effectiveness against Gram-negative bacteria, especially Pseudomonas species.

Antimicrobial preservatives useful in the present invention include biocidal compounds, i.e., substances that kill microorganisms, or biostatic compounds, i.e., substances that inhibit and/or regulate the growth of microorganisms. Well known preservatives such as short chain alkyl esters of p-hydroxybenzoic acid, commonly known as parabens; N-(4-chlorophenyl)-N′-(3,4-dichlorophenyl) urea, also known as 3,4,4′-trichlorocarbanilide or triclocarban; 2,4,4′-trichloro-2′-hydroxy diphenyl ether, commonly known as triclosan are useful preservative in the present invention.

Still other preferred preservatives are the water-soluble preservatives, i.e. those that have a solubility in water of at least about 0.3 g per 100 ml of water, i.e., greater than about 0.3% at room temperature, preferably greater than about 0.5% at room temperature.

The preservative in the present invention is included at an effective amount. The term “effective amount” as herein defined means a level sufficient to prevent spoilage, or prevent growth of inadvertently added microorganisms, for a specific period of time. In other words, the preservative is not being used to kill microorganisms on the surface onto which the composition is deposited in order to eliminate odors produced by microorganisms. Instead, it is preferably being used to prevent spoilage of the solution in order to increase the shelf-life of the composition. Preferred levels of preservative are from about 0.0001% to about 0.5%, more preferably from about 0.0002% to about 0.2%, most preferably from about 0.0003% to about 0.1%, by weight of the usage composition.

The preservative can be any organic preservative material which will not cause damage to fabric appearance, e.g., discoloration, coloration, bleaching. Preferred water-soluble preservatives include organic sulfur compounds, halogenated compounds, cyclic organic nitrogen compounds, low molecular weight aldehydes, quaternary ammonium compounds, dehydroacetic acid, phenyl and phenolic compounds, and mixtures thereof. Non-limiting examples of preferred water-soluble preservatives for use in the present invention can be found in U.S. Pat. No. 5,714,137, incorporated hereinbefore by reference, as well as co-pending application PCT/US 98/12154 pages 29 to 36.

Preferred water-soluble preservatives for use in the present invention are organic sulfur compounds. Some non-limiting examples of organic sulfur compounds suitable for use in the present invention are:
a) 3-Isothiazolone Compounds

A preferred preservative is an antimicrobial, organic preservative containing 3-isothiazolone groups. This class of compounds is disclosed in U.S. Pat. No. 4,265,899, Lewis et al., issued May 5, 1981, and incorporated herein by reference. A preferred preservative is a water-soluble mixture of 5-chloro-2-methyl-4-isothiazolin-3-one and 2-methyl-4-isothiazolin-3-one, more preferably a mixture of about 77% 5-chloro-2-methyl-4-isothiazolin-3-one and about 23% 2-methyl-4-isothiazolin-3-one, a broad spectrum preservative available as a about 1.5% aqueous solution under the trade name Kathon® CG by Rohm and Haas Company.

When Kathon® is used as the preservative in the present invention it is present at a level of from about 0.0001% to about 0.01%, preferably from about 0.0002% to about 0.005%, more preferably from about 0.0003% to about 0.003%, most preferably from about 0.0004% to about 0.002%, by weight of the composition.

Other isothiazolins include 1,2-benzisothiazolin-3-one, available under the trade name Proxel® products; and 2-methyl-4,5-trimethylene-4-isothiazolin-3-one, available under the trade name Promexal®. Both Proxel and Promexal are available from Zeneca. They have stability over a wide pH range (i.e., 4-12). Neither contain active halogen and are not formaldehyde releasing preservatives. Both Proxel and Promexal are effective against typical Gram negative and positive bacteria, fungi and yeasts when used at a level from about 0.001% to about 0.5%, preferably from about 0.005% to about 0.05%, and most preferably from about 0.01% to about 0.02% by weight of the usage composition.
b) Sodium Pyrithione

Another preferred organic sulfur preservative is sodium pyrithione, with water solubility of about 50%. When sodium pyrithione is used as the preservative in the present invention it is typically present at a level of from about 0.0001% to about 0.01%, preferably from about 0.0002% to about 0.005%, more preferably from about 0.0003% to about 0.003%, by weight of the usage composition.

Mixtures of the preferred organic sulfur compounds can also be used as the preservative in the present invention.

10. Antimicrobial Agents

Sanitization of fabrics can be achieved through the use of compositions containing, antimicrobial materials, e.g., antibacterial halogenated compounds, quaternary compounds, phenolic compounds and metallic salts, and preferably quaternary compounds. A typical disclosure of these antimicrobial can be found in International Patent Application No. PCT/US 98/12154 pages 17 to 20.
a) Biguanides

Some of the more robust antimicrobial halogenated compounds which can function as disinfectants/sanitizers as well as finish product preservatives (vide infra), and that are useful in the compositions of the present invention include 1,1′-hexamethylene bis(5-(p-chlorophenyl)biguanide), commonly known as chlorhexidine, and its salts, e.g., with hydrochloric, acetic and gluconic acids. The digluconate salt is highly water-soluble, about 70% in water, and the diacetate salt has a solubility of about 1.8% in water.

Other useful biguanide compounds include Cosmoci® CQ®, and Vantocil® IB that include poly (hexamethylene biguanide) hydrochloride. Other useful cationic antimicrobial agents include the bis-biguanide alkanes. Usable water soluble salts of the above are chlorides, bromides, sulfates, alkyl sulfonates such as methyl sulfonate and ethyl sulfonate, phenylsulfonates such as p-methylphenyl sulfonates, nitrates, acetates, gluconates, and the like.

Examples of suitable bis biguanide compounds are chlorhexidine; 1,6-bis-(2-ethylhexylbiguanidohexane)dihydrochloride; 1,6-di-(N₁,N₁′-phenyldiguanido-N₅,N₅′)-hexane tetrahydrochloride; 1,6-di-(N₁,N₁′-phenyl-N₁,N₁′-methyldiguanido-N₅,N₅′)-hexane dihydrochloride; 1,6-di(N₁,N₁′-o-chlorophenyldiguanido-N₅,N₅′)-hexane dihydrochloride; 1,6-di(N₁,N₁′-2,6-dichlorophenyldiguanido-N₅,N₅′)hexane dihydrochloride; 1,6-di[N₁,N₁′-.beta.-(p-methoxyphenyl) diguanido-N₅,N₅′]-hexane dihydrochloride; 1,6-di(N₁,N₁′-.alpha.-methyl-.beta.-phenyldiguanido-N₅,N₅′)-hexane dihydrochloride; 1,6-di(N₁,N₁′-p-nitrophenyldiguanido-N₅,N₅′)hexane dihydrochloride; .omega.:.omega.′-di-(N₁,N₁′-phenyldiguanido-N₅,N₅′)-di-n-propylether dihydrochloride; omega:omega′-di(N₁,N₁′-p-chlorophenyldiguanido-N₅,N₅′)-di-n-propylether tetrahydrochloride; 1,6-di(N₁,N₁′-2,4-dichlorophenyldiguanido-N₅,N₅′)hexane tetrahydrochloride; 1,6-di(N₁,N₁′-p-methylphenyldiguanido-N₅,N₅′)hexane dihydrochloride; 1,6-di(N₁,N₁′-2,4,5-trichlorophenyldiguanido-N₅,N₅′)hexane tetrahydrochloride; 1,6-di[N₁,N₁′-.alpha.-(p-chlorophenyl) ethyldiguanido-N₅,N₅′] hexane dihydrochloride;.omega.:.omega.′di(N₁, N₁′-p-chlorophenyldiguanido-N₅,N₅′)m-xylene dihydrochloride; 1,12-di(N₁,N₁′-p-chlorophenyldiguanido-N₅,N₅′) dodecane dihydrochloride; 1,10-di(N₁,N₁′-phenyldiguanido-N₅,N₅′)-decane tetrahydrochloride; 1,12-di(N₁,N₁′-phenyldiguanido-N₅,N₅′) dodecane tetrahydrochloride; 1,6-di(N₁,N₁′-o-chlorophenyldiguanido-N₅,N₅′) hexane dihydrochloride; 1,6-di(N₁,N₁′-p-chlorophenyldiguanido-N₅,N₅′)-hexane tetrahydrochloride; ethylene bis (1-tolyl biguanide); ethylene bis (p-tolyl biguanide); ethylene bis(3,5-dimethylphenyl biguanide); ethylene bis(p-tert-amylphenyl biguanide); ethylene bis(nonylphenyl biguanide); ethylene bis (phenyl biguanide); ethylene bis (N-butylphenyl biguanide); ethylene bis (2,5-diethoxyphenyl biguanide); ethylene bis(2,4-dimethylphenyl biguanide); ethylene bis(o-diphenylbiguanide); ethylene bis(mixed amyl naphthyl biguanide); N-butyl ethylene bis(phenylbiguanide); trimethylene bis(o-tolyl biguanide); N-butyl trimethylene bis(phenyl biguanide); and the corresponding pharmaceutically acceptable salts of all of the above such as the acetates; gluconates; hydrochlorides; hydrobromides; citrates; bisulfites; fluorides; polymaleates; N-coconutalkylsarcosinates; phosphites; hypophosphites; perfluorooctanoates; silicates; sorbates; salicylates; maleates; tartrates; fumarates; ethylenediaminetetraacetates; iminodiacetates; cinnamates; thiocyanates; arginates; pyromellitates; tetracarboxybutyrates; benzoates; glutarates; monofluorophosphates; and perfluoropropionates, and mixtures thereof. Preferred antimicrobials from this group are 1,6-di-(N₁,N₁′-phenyldiguanido-N₅,N₅′)-hexane tetrahydrochloride; 1,6-di(N₁,N₁′-o-chlorophenyldiguanido-N₅,N₅′)-hexane dihydrochloride; 1,6-di(N₁,N₁′-2,6-dichlorophenyldiguanido-N₅,N₅′)hexane dihydrochloride; 1,6-di(N₁,N₁′-2,4-dichlorophenyldiguanido-N₅,N₅′)hexane tetrahydrochloride; 1,6-di[N₁,N₁′-.alpha.-(p-chlorophenyl) ethyldiguanido-N₅,N₅′] hexane dihydrochloride;.omega.:.omega.′di(N₁, N₁′-p-chlorophenyldiguanido-N₅,N₅′)m-xylene dihydrochloride; 1,12-di(N₁,N₁′-p-chlorophenyldiguanido-N₅,N₅′) dodecane dihydrochloride; 1,6-di(N₁,N₁′-o-chlorophenyldiguanido-N₅,N₅′) hexane dihydrochloride; 1,6-di(N₁,N₁′-p-chlorophenyldiguanido-N₅,N₅′)-hexane tetrahydrochloride; and mixtures thereof; more preferably, 1,6-di(N₁,N₁′-o-chlorophenyldiguanido-N₅,N₅′)-hexane dihydrochloride; 1,6-di(N₁,N₁′-2,6-dichlorophenyldiguanido-N₅,N₅′)hexane dihydrochloride; 1,6-di(N₁,N₁′-2,4-dichlorophenyldiguanido-N₅,N₅′)hexane tetrahydrochloride; 1,6-di[N₁,N₁′-.alpha.-(p-chlorophenyl) ethyldiguanido-N₅,N₅′] hexane dihydrochloride;.omega.:.omega.′di(N₁,N₁′-p-chlorophenyldiguanido-N₅,N₅′)m-xylene dihydrochloride; 1,12-di(N₁,N₁′-p-chlorophenyldiguanido-N₅,N₅′) dodecane dihydrochloride; 1,6-di(N₁,N₁′-o-chlorophenyldiguanido-N₅,N₅′) hexane dihydrochloride; 1,6-di(N₁,N₁′-p-chlorophenyldiguanido-N₅,N₅′)-hexane tetrahydrochloride; and mixtures thereof. As stated hereinbefore, the bis biguanide of choice is chlorhexidine its salts, e.g., digluconate, dihydrochloride, diacetate, and mixtures thereof.
b) Quaternary Compounds

A wide range of quaternary compounds can also be used as antimicrobial actives for the compositions of the present invention. Non-limiting examples of useful quaternary compounds include: (1) benzalkonium chlorides and/or substituted benzalkonium chlorides such as commercially available Barquat® (available from Lonza), Maquat® (available from Mason), Variquat® (available from Goldschmidt), and Hyamine® (available from Lonza); (2) di(C₆-C₁₄)alkyl di short chain (C₁₋₄ alkyl and/or hydroxyalkyl) quaternary such as Bardac® products of Lonza, (3) N-(3-chloroallyl) hexaminium chlorides such as Dowicide® and Dowicil® available from Dow; (4) benzethonium chloride such as Hyamine® 1622 from Rohm & Haas; (5) methylbenzethonium chloride represented by Hyamine® 10× supplied by Rohm & Haas, (6) cetylpyridinium chloride such as Cepacol chloride available from of Merrell Labs. Examples of the preferred dialkyl quaternary compounds are di(C₈-C₁₂)dialkyl dimethyl ammonium chloride, such as didecyldimethylammonium chloride (Bardac 22), and dioctyldimethylammonium chloride (Bardac 2050).

Surfactants, when added to the antimicrobials tend to provide improved antimicrobial action. This is especially true for the siloxane surfactants, and especially when the siloxane surfactants are combined with the chlorhexidine antimicrobial actives.

Examples of bactericides used in the compositions and articles of this invention include glutaraldehyde, formaldehyde, 2-bromo-2-nitro-propane-1,3-diol sold by Inolex Chemicals, located in Philadelphia, Pa., under the trade name Bronopol®, and a mixture of 5-chloro-2-methyl-4-isothiazoline-3-one and 2-methyl-4-isothiazoline-3-one sold by Rohm and Haas Company under the trade name Kathon CG/ICP®.
c) Metallic Salts

Many metallic salts are known for their antimicrobial effects. These metallic salts may be selected from the group consisting of copper salts, zinc salts, and mixtures thereof.

Copper salts have some antimicrobial benefits. Specifically, cupric abietate acts as a fungicide, copper acetate acts as a mildew inhibitor, cupric chloride acts as a fungicide, copper lactate acts as a fungicide, and copper sulfate acts as a germicide. Copper salts also possess some malodor control abilities. For instance, U.S. Pat. No. 3,172,817, Leupold, et al., describes deodorizing compositions for treating disposable articles, comprising at least slightly water-soluble salts of acylacetone, including copper salts and zinc salts.

11. Other Optionals

The present invention composition may also include optional components conventionally used in textile treatment compositions, for example: brighteners, photoactivated bleaching agents such as the sulfonated zinc and/or aluminum phthalocyanines, perfumes, chlorine scavengers, colorants; surfactants; anti-shrinkage agents; fabric crisping agents; spotting agents; germicides; fungicides; anti-oxidants such as butylated hydroxy toluene, anti-corrosion agents, and mixtures thereof.

### II. FORM OF THE COMPOSITION

The composition of the invention may take a variety of physical forms including liquid, liquid-gel, paste-like, foam in either aqueous or non-aqueous form, powder, granular and tablet forms. For better dispersibility, a preferred form of the composition is a liquid form. When in a liquid form, the composition may also be dispensed with dispensing means such as a sprayer or aerosol dispenser.

### III. METHODS OF USE

Rinse Process

The composition can be used in a so-called rinse process, where a composition as defined hereinabove, is first diluted in an aqueous rinse bath solution. Subsequently, the laundered fabrics which have been washed with a detergent liquor and optionally rinsed in a first inefficient rinse step (“inefficient” in the sense that residual detergent and/or soil may be carried over with the fabrics), are placed in the rinse solution with the diluted composition. Of course, the composition may also be incorporated into the aqueous bath once the fabrics have been immersed therein. Following that step, agitation is applied to the fabrics in the rinse bath solution causing the suds to collapse, and residual soils and surfactant is to be removed. The fabrics can then be optionally wrung before drying.

Accordingly, there is provided a method for rinsing fabrics, which comprises the steps of contacting fabrics, previously washed in a detergent liquor, with a composition of the invention. Likewise, the present invention provides for the use of a composition of the present invention to impart fabric softness to fabrics that have been washed in a high suds detergent solution, while providing in the rinse a reduction of suds or foaming and without the creation of undesirable flocs.

This rinse process may be performed manually in basin or bucket, in a non-automated washing machine, or in an automated washing machine. When hand washing is performed, the laundered fabrics are removed from the detergent liquor and wrung out. The composition of the invention is then added to fresh water and the fabrics are then, directly or after an optional inefficient first rinse step, rinsed in the water containing the composition according to the conventional rinsing habit. The fabrics are then dried using conventional means.

### IV. TEST METHODS AND EXAMPLES

Examples 1, 2 and 3 exemplify the invention, while examples 4 and 5 do not pass the floc formation test (ex. 4) or the suds reduction test (ex. 5).

| | Example 1 | Example 2 | Example 3 | Example 4 | Example 5 |
|---|---|---|---|---|---|
| Rewoquat V3282, | 5 | 6.5 | | 6 | 5.5 |
| Ex Goldschmidt (1) | | | | | |
| LF-DEEDMAC (2) | — | — | 8 | — | — |
| HCl | 0.02 | 0.01 | 0.02 | 0.01 | 0.01 |
| Perfume | 0.8 | 0.9 | 0.9 | 1.1 | 0.25 |
| Neodol 91-8, | 1 | 0.5 | — | 0.5 | — |
| Ex Shell | | | | | |
| Silicone Emulsion | 0.75 | — | 0.75 | — | — |
| SE39, Ex Wacker | | | | | |
| Silicone emulsion | — | 2.0 | — | 2.0 | — |
| MP10, Ex Dow Corning | | | | | |
| N-Cocoyl,N,N | 3 | — | — | — | — |
| dimethyl,N- | | | | | |
| hydroxylethyl | | | | | |
| ammonium chloride | | | | | |
| Dodecyl trimethyl | — | 4 | — | — | 4.0 |
| ammonium chloride | | | | | |
| Water | Balance | Balance | Balance | Balance | Balance |

(1) Di (stearoyloxyethyl) Dimethyl ammonium chloride, 85% activity
(2) Reaction product of Fatty acid with Methyldiethanolamine in a molar ratio 1.5:1, quaternized with Methylchloride, resulting in a 1:1 molar mixture of N,N-bis(stearoyl-oxy-ethyl)N,N-dimethyl ammonium chloride and N-(stearoyl-oxy-ethyl) N,-hydroxyethyl N,N dimethyl ammonium chloride.

Floc Formation Test Method

The absence of floc formation in a rinse solution containing residual anionic surfactant is an essential feature of the invention. Floc formation is evaluated according to the following test method: 750 grams of a dodecylbenzenesulfonic acid, sodium salt (technical grade, supplied by Aldrich under the catalog number 28,995-7) solution at about 0.02% (using water at 20°-25° C. and 12 US gpg hardness) is added to a 1 liter cylindrical jar (with a diameter to height ratio of approx. 5 to 8). The jar is closed hermetically and shaken vigorously during 15 seconds to generate about 3 cm of foam on top of the solution.

Following this, 5 grams of the composition to be tested is poured on the surface of the foamed solution. The solution in the beaker is then manually stirred for 30 seconds at the rate of 100 rpm (with a 20 cm long, 0.5 cm plastic spatula). One minute after the stirring the solution is poured evenly over the surface of a USA Standard testing sieve (ASTM E11 specification No. 40, 35 mesh Tyler equivalent, opening 425 micron, sieve diameter 8 inch) which has been placed in a collecting tray. The dimensions of this tray are such that at the wires of the sieve are at least 1 cm below the surface of the liquid in the tray once the full 750 grams of test solution has been added. The sieve is subsequently manually lifted out of the tray (kept horizontically) and inspected for the presence of flocs. The test solution is being defined as being “substantially free” from flocs if the total number of visible flocs retained on the sieve is less than 50. The test solution is being defined as being “free” from flocs if the number of visible flocs retained is less than 10. The filtrate is collected in an identical 1 liter jar.

Suds Reduction Test

The suds reduction property of the hand composition is another essential feature of the invention. Suds reduction is defined according to the following test method: 750 grams of a dodecylbenzenesulfonic acid, sodium salt (technical grade, supplied by Aldrich under the catalog number 28,995-7) solution at about 0.02% (using water at 20°-25° C. and 12 US gpg hardness) is added to a 1 liter cylindrical jar (with a diameter to height ratio of approx. 5 to 8). This solution serves as reference. Both the reference solution and the filtrate obtained from the Floc Formation Test (see above) are shaken vigorously for about 15 seconds. This generates about 3 cm of foam on top of the reference solution. The remaining presence of foam on the test solution is assessed visually, 15 seconds after the shaking has finished. Suitable compositions are those that have a suds reduction over the reference of about at least about 90%, preferably of at least about 95% and most preferably of at least about 99%. 99% is where all the foam disappeared apart from the optional presence of a white film or some scattered air bubbles that may partially cover the surface of the solution.

| | | Free from | Suds |
|---|---|---|---|
| Product | Made by | flocs | reduction |
| Suavitel Fresco primavera, | Colgate | No | 73% |
| 1 Liter bottle, Mexico, | | | |
| code 0161MH311E | | | |
| Comfort Vitality, | Unilever | No | 33% |
| 750 ml bottle, UK | | | |
| code 0259015PS6 | | | |
| Downy Aroma del Bosque, | P&G | No | 67% |
| 1 L bottle, Mexico | | | |
| code 02170300 | | | |
| Silan Tender Rose, | Henkel | No | 87% |
| 6 L bottle, Belgium | | | |
| code 8101820 | | | |
| Silan Sensations Cool Breeze, | Henkel | No | 43% |
| 2 L bottle, Belgium | | | |
| code 50294B21 | | | |
| Robijn Morgenfris, | Unilever | No | 67% |
| 1 L bottle, Belgium | | | |
| code 25.10.00 PZ4 | | | |
| Comfort Easy Iron, | Unilever | No | 50% |
| 750 ml bottle, UK | | | |
| code 91721913PS6 | | | |
| Ultra Soupline Fraicheur, | Colgate | No | 83% |
| 1 L Refill, France | | | |
| code 0340FR13120 | | | |
| Lenor Spring Awakening, | P&G | No | 73% |
| 1 L Bottle, UK | | | |
| code 02380303B8 | | | |
| Quanto Ultra NaturFrisch, | Benckiser | No | 47% |
| 1 L Refill, Germany | | | |
| code 9435F1 | | | |
| Lenor Spring Awakening, | P&G | No | 83% |
| 500 ml Refill, Czech | | | |
| Republic | | | |
| code 0146272321 | | | |
| Mimosin, | Unilever | No | 60% |
| 3 L bottle, Spain | | | |
| code 026610 15AD | | | |
| Example 1 | | Yes | 99% |
| Example 2 | | Yes | 99% |
| Example 3 | | Yes | 99% |
| Example 4 | | No | 99% |
| Example 5 | | Yes | 80% |

Softness Robustness Test Method

The influence of the presence of anionic surfactant in the rinse solution on the softness performance delivered by the test composition is evaluated according to the following method:

To a first 1 liter cylindrical jar (with a diameter to height ratio of approx. 5 to 8) 400 grams of demineralised water is added, to a second identical jar 400 grams of a dodecylbenzenesulfonic acid, sodium salt (technical grade, supplied by Aldrich under the catalog number 28,995-7) solution at about 0.02% (using demineralised water at 20°-25° C.) is added. To the second jar an amount of test composition is added such that the level of fabric softener active (as defined here above) in the final solution is in the range of about 0.02% to about 0.04%. To the first jar the same test composition is added, at about 75% of the level which has been added into the second jar.

One piece of cotton terry fabric (at least 3 times washed at about 60 degrees using a commercial detergent), about 40 grams in weight, is added to both jars. The jars are shaken on an orbital shaker (at 200 rpm) for about 5 minutes. Following this the fabrics are removed from the jar and wrung out until they contain about their own weight of water. The fabric treated in the first jar is denoted “Reference”, the fabric treated in the second jar is denoted “Test”. The fabrics are line dried over night and their hand is evaluated by an expert panel consisting of 2 judges, who are asked to express their preference for either the Test fabric or the Reference fabric. This test is repeated 10 times (yielding 20 comparisons in total). Suitable compositions are those for which the Test fabric is not rated significantly lower in softness compared to the Reference fabric (i.e. less than 15 comparisons out of 20 are in favor of the Reference product).

Downy Aroma Del Bosque (P&G, Mexico), Suavitel Fresca Primavera (Colgate, Mexico) and Example 3 fail this test. Examples 1 & 2 pass this test.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A method of whitening a fabric in a manual rinse process comprising the steps:
(a) adding a conditioning composition to a first rinse bath solution;
(b) manually rinsing the fabric in the first rinse bath solution;
wherein the composition comprises: an optical brightener and a suds suppressing system.

2. The method according to claim 1, wherein the composition further comprises a fabric softener active.

3. The method according to claim 2, wherein the fabric softener active comprises a dialkyl substituted quaternary ammonium compound.

4. The method according to claim 3, wherein the composition further comprises a surfactant scavenger.

5. The method according to claim 4, wherein the surfactant scavenger comprises a monoalkyl variant of the fabric softening active.

6. The method according to claim 1, wherein the first rinse bath solution is a single rinse bath solution.

7. The method according to claim 5, wherein the first rinse bath solution is a single rinse bath solution.
